(19) United States
(12) Patent Application Publication
(10) Pub. No.: US 2010/0235998 A1
(43) Pub. Date: Sep. 23, 2010

(54) Putty knife with function of detaching and/or tightening screwed members

(76) Inventor: Shou-Hung Chen, Taipei (TW)

Correspondence Address: Muncy, Geissler, Olds & Lowe, PLLC, 4000 Legato Road, Suite 310, FAIRFAX, VA, 22033, US

(21) Appl. No.: 12/003,221

(22) Filed: Dec. 20, 2007

(51) Int. Cl. B25F 1/00

(52) U.S. Cl. 7/138; 7/165

(57) ABSTRACT

A putty knife with function of detaching and/or tightening screwed members is disclosed. The putty knife comprises a handle and a blade disposed in one end of the handle, wherein at least one fitting part is disposed at the handle for adapting a wrench or a wrench socket to detach or tighten screwed members such as screws, bolts, nuts or the like.

### FIELD OF THE INVENTION

The present invention relates to a putty knife with function of detaching and/or tightening screwed members, and more particularly, to a putty knife with at least one fitting part disposed in the handle for turning screwed members such as bolts, nuts or the like.

### DESCRIPTION OF THE PRIOR ART

The putty knife commonly sold in stores, as shown in FIG. 10, has a handle a1 and a blade end a2 for scraping surfaces or spreading around material such as putty or plaster on a rough surface in various construction trades. The conventional putty knife is usually made from wood, metal or plastic. However, the handle a1 of the putty knife needs more material for manufacturing but has limited use. In addition, the conventional putty knife a is wasteful of resources that it may be thrown away after used, and cause environmental pollution.

A further disadvantage is found in that, while prior putty knife fulfills the basic need to scrape and spread, it is often desirable to have a multi-function tool to putty knife even further into the fabric of every day life, and thus a multi-function putty knife may be the next step in the putty knife revolution. In addition, further limitations and disadvantages of conventional and traditional approaches will become apparent to one of skill in the art, through comparison of such a putty knife with some aspects of the present invention as set forth in the remainder of the present application with reference to the drawing.

In view of this, the inventor provides a putty knife with low manufacturing cost and versatility in screwing on or off screws that can increase product competitiveness, and the abovementioned problem can thus be solved.

### SUMMARY OF THE INVENTION

It is an objective of the present invention to provide a putty knife convenient to grip for scraping surfaces or spreading material. The putty knife has a dual function being like a wrench.

It is another objective of the present invention to provide a putty knife with function of detaching and/or tightening screwed members. The putty knife includes at least one fitting part in the handle for adapting a wrench or a wrench socket to detach or tighten screwed members such as screws, bolts, nuts or the like.

It is still another objective of the present invention to provide a putty knife with function of detaching and/or tightening screwed members, wherein the fitting part is disposed at the handle to directly turn screwed members such as screws, bolts, nuts or similarly shaped objects.

To achieve the above stated objectives, the present invention provides a putty knife with function of detaching and/or tightening screwed members, wherein the putty knife comprises a handle and a blade disposed in one end of the handle, and at least one fitting part is disposed at the handle for detaching or tightening the screwed members such as screws, bolts, nuts or the like.

According to an embodiment of the present invention, the fitting part is preferably an opening for adapting a wrench or a wrench socket to turn the screwed members.

According to an embodiment of the present invention, the handle is provided with a plurality of openings, and each opening preferably has a specific geometrical shape.

Various advantages, aspects and novel features of the present invention as well as details of an illustrated embodiment thereof, will be more fully understood from the following description and drawings.

### BRIEF DESCRIPTION OF THE DRAWINGS

FIG. 1 is a perspective view of the first embodiment of the putty knife according to the present invention;

FIG. 2 is a perspective view of the first embodiment showing attachment of the socket to the fitting part;

FIG. 3 is a perspective view of the first embodiment showing fitting of the hex key to the fitting part;

FIG. 4 is a perspective view of the second embodiment of the putty knife according to the present invention;

FIG. 5 is a perspective view of the second embodiment showing operation of the fitting part with a hexagonal bolt;

FIG. 6 is a perspective view of the third embodiment of the putty knife according to the present invention;

FIG. 7 is a perspective view of the third embodiment showing operation of the fitting part with a hexagonal bolt;

FIG. 8 is a perspective view of the fourth embodiment of the putty knife according to the present invention;

FIG. 9 is a perspective view of the fifth embodiment of the putty knife according to the present invention;

FIG. 10 is a perspective view of a conventional putty knife.

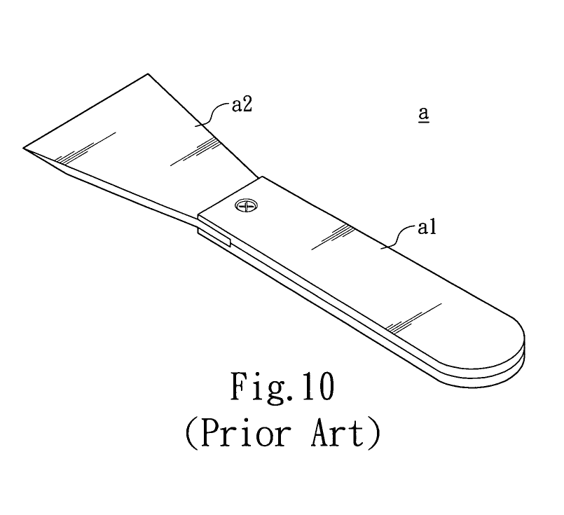

### DETAILED DESCRIPTION OF THE PREFERRED EMBODIMENT

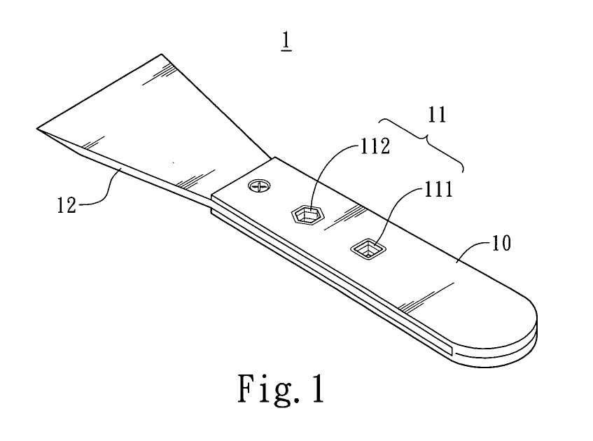

Referring to FIG. 1, there is illustrated a first embodiment of a putty knife 1 with function of detaching and/or tightening screwed members of the present invention, the putty knife 1 includes a handle 10 for holding by user and a blade 12 disposed in one end of the handle 10, and the handle 10 is provided with at least one fitting part 11 for detaching and/or tightening screwed members.

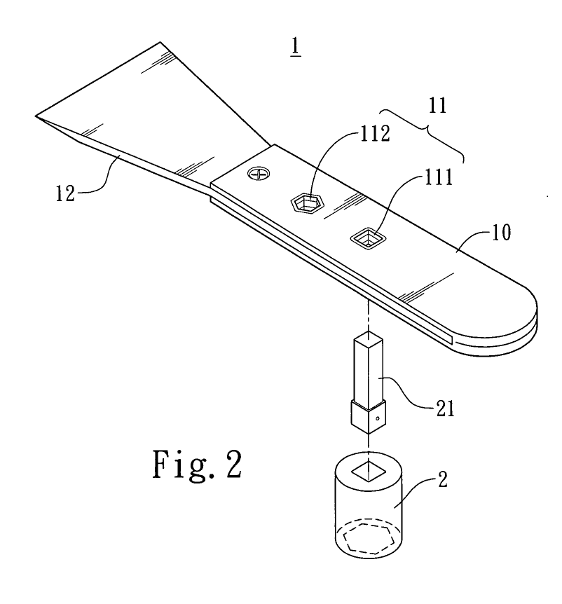

In this embodiment, the handle 10 is provided with a first fitting part 111 and a second fitting part 112. The first fitting part 111 is a square-shaped opening for use with nuts or screw/bolt heads with a square shape. In addition, the first fitting part 111 may also be attached with a removable socket 2 in hexagonal configuration through a square adaptor 21 that locks onto them (as shown in FIG. 2), such that screws and bolts with hexagonal gripping surfaces can be turned through the socket.

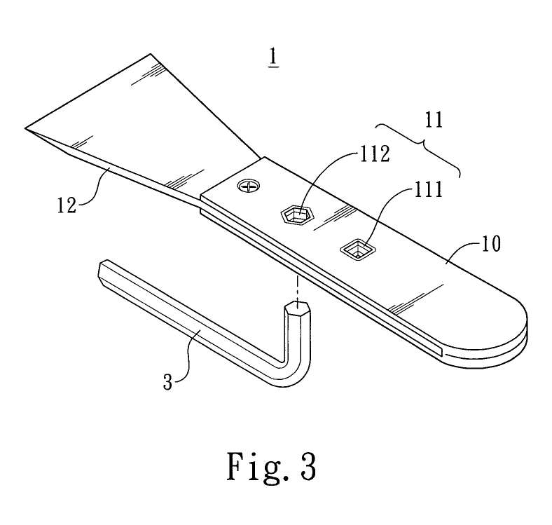

The second fitting part 112 is a hexagonal opening for use with nuts or screw/bolt heads with a hexagonal shape. The second fitting part 112 also can fit onto a hex key 3 (as shown is FIG. 3) to make the work of fastening or detaching screws or bolts that have a hexagonal head easier for use.

In practice, the handle 10 of the present invention is preferably constructed of simple metals or plastics, and the blade 12 of the present invention is preferably made from metal.

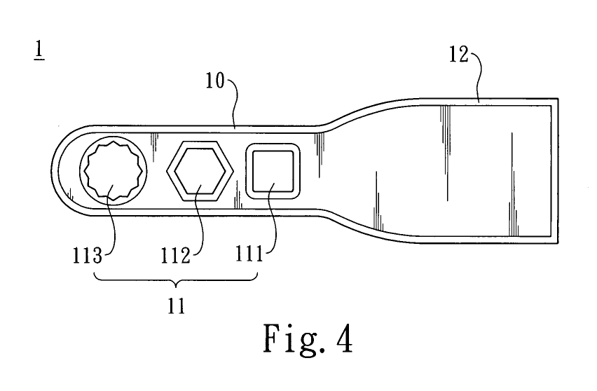

Referring to FIG. 4, there is illustrated a second embodiment of a putty knife 1 with function of detaching and/or tightening screwed members of the present invention, wherein the putty knife 1 includes a handle 10 for holding by user and a blade 12 disposed in one end of the handle 10, and the handle 10 is provided with at least one fitting part 11 for detaching and/or tightening screwed members.

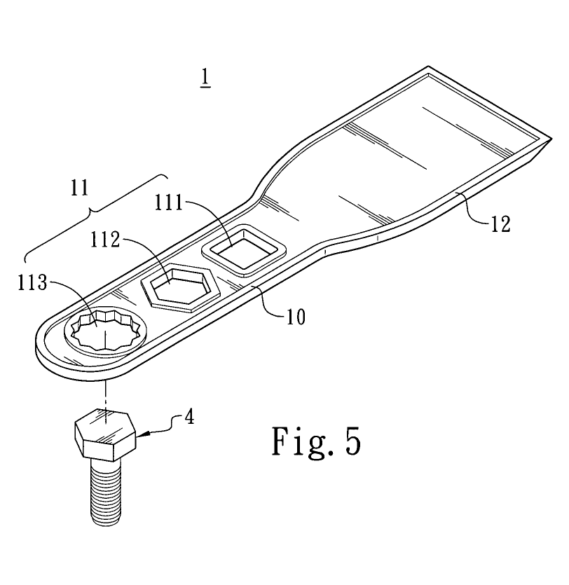

In this embodiment, the handle 10 is provided with a first fitting part 111, a second fitting part 112 and a third fitting part 113. As in the previous embodiment, the first fitting part 111 is a square-shaped opening and the second fitting part 112 is a hexagonal opening for use with nuts or screw/bolt heads with an adequate shape to the opening, or for adapting a removable socket or a hex key to turn the screws and bolts. The third fitting part 113 is an opening in a twelve-point (double-hexagonal) configuration for offering a better grip on fittings to nuts, screw or bolt 4 heads with a hexagonal shape, and is less likely to slip and round off the corners (as shown in FIG. 5).

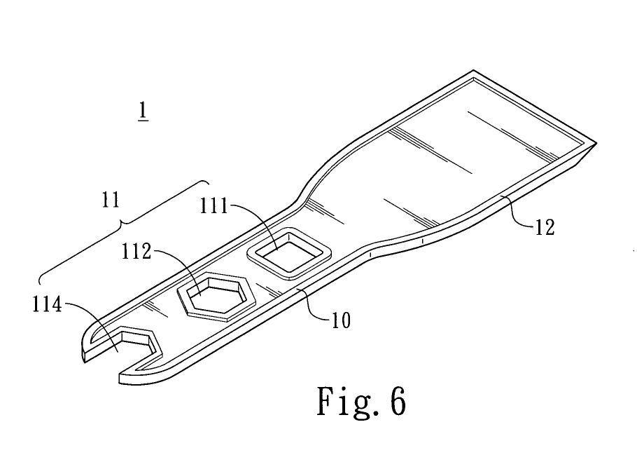

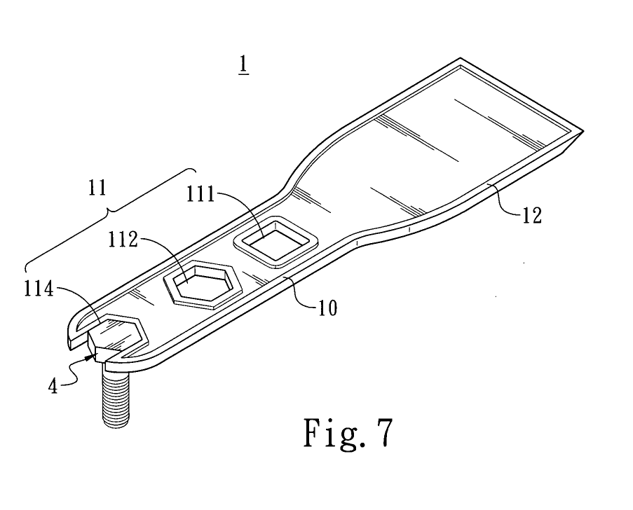

Further, there is a fourth fitting part 114 provided in the end relative to the blade 12 (as shown in FIG. 6). The fourth fitting part 114 is an U-shaped opening that grips two opposite faces of nuts, screw or bolt 4 heads with a hexagonal shape (as shown in FIG. 7).

In practice, the handle 10 and the blade 12 of the present invention is integrally formed as a single piece of plastic or metal.

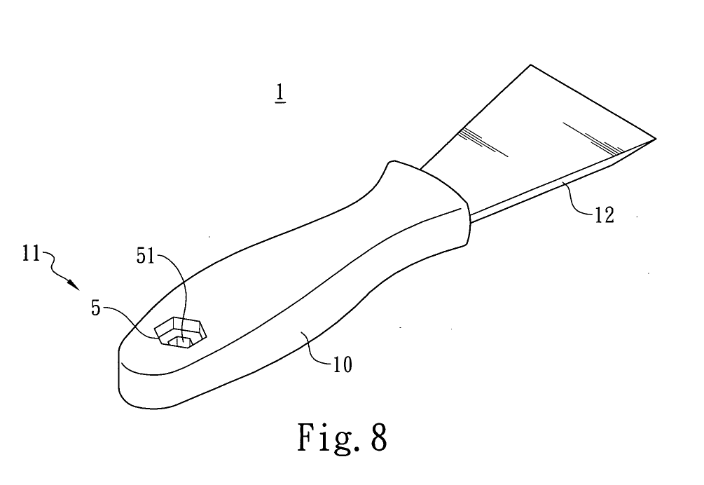

Referring to FIG. 8, there is illustrated a third embodiment of a putty knife 1 with function of detaching and/or tightening screwed members of the present invention, wherein a fitting part 11 is provided in the handle 10 of the putty knife 1. The fitting part 11 is an opening 5 in a hexagonal shape, which forms a two-step structure with a lower step 51 in a hexagonal shape. Thus, the fitting part 5 of the putty knife 1 can fit onto two hex keys with different sizes by the upper step and the lower step to make the work of fastening or detaching screws or bolts that have a hexagonal head easier for use.

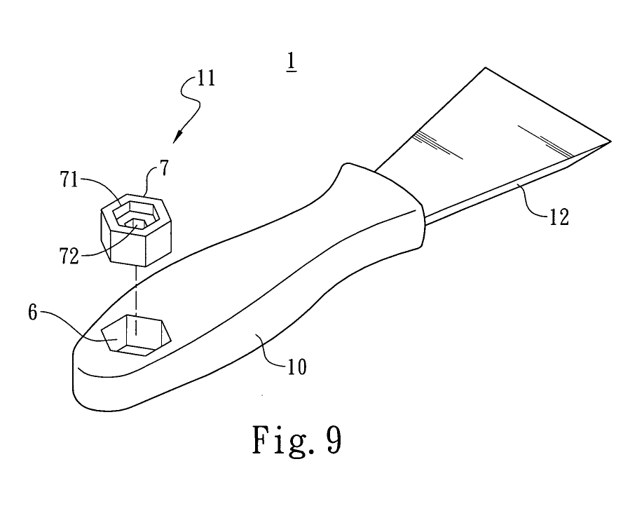

Referring to FIG. 9, there is illustrated a fourth embodiment of a putty knife 1 with function of detaching and/or tightening screwed members of the present invention, wherein the fitting part 11 is a hexagonal socket 7, and the handle 10 has a hexagonal receiving groove 6 designed for receiving the socket 7. The socket 7 has an opening 71 with a two-step structure, and the lower step of the opening 71 forms a hexagonal hole 72 such that the socket 7 can fit onto two hex keys with different sizes by the upper step of the opening 71 and the hexagonal hole 72 to make the work of fastening or detaching screws or bolts that have a hexagonal head easier for use.

In application, the putty knife of the present invention can be used for scraping surfaces or spreading material on a rough surface, and for fastening or detaching screws, bolts, nuts or the like directly or by adapting a removable socket or a hex key.

Therefore, the present invention has following advantages:

1. The putty knife according to the present invention has a dual function being like a wrench, and can be extensively applied to a tightening tool that uses separate, removable sockets to fit many different sizes of fittings and fasteners such as screws and nuts.

2. The handle and the blade of the putty knife according to the present invention can be integrally formed as a single piece of plastic or metal to lower the manufacturing cost, and the putty knife can function as a wrench to turn screws to increases the competitive power of product.

3. The fitting part of the putty knife according to the present invention can manipulate pieces of different shapes and sizes to facilitate user detaching or tightening the screwed members.

4. The putty knife of the present invention has high utilization value in industry, and can be extensively applied to prevent the putty knife from being thrown when it has a blunt blade to decrease environmental pollution.

As stated in the above disclosed, the present invention can surely achieve its expected objects to provide a putty knife with function of detaching and/or tightening screwed members and provides less or no additional cost of materials associated with manufacture.

It should be understood that different modifications and variations could be made from the disclosures of the present invention by the people familiar in the art without departing the spirit of the present invention.

1. A putty knife with function of detaching and/or tightening screwed members, comprising:
a blade;
a handle, wherein the blade is hold or integrally formed on the handle; and
at least one fitting part disposed at the handle for detaching and/or tightening screwed members.

2. The putty knife as claimed in claim 1, wherein the fitting part is an opening for adapting a wrench or a wrench socket to turn the screwed members.

3. The putty knife as claimed in claim 2, wherein the wrench is a hex key.

4. The putty knife as claimed in claim 2, wherein the handle is provided with a plurality of openings, and each opening has a specific geometrical shape.

5. The putty knife as claimed in claim 2, wherein the fitting part is an opening which forms a step structure.

6. The putty knife as claimed in claim 1, wherein the fitting part is a socket, and the handle is provided with a receiving groove for receiving the socket to adapt a wrench or a wrench socket to turn the screwed members.
